(19) United States
(12) Patent Application Publication
(10) Pub. No.: US 2022/0290375 A1
(43) Pub. Date: Sep. 15, 2022

(54) MULTILAYERED FIRE-RESISTANT SHEET

(71) Applicant: DUPONT SAFETY & CONSTRUCTION, INC., Wilmington, DE (US)

(72) Inventors: BYOUNG SAM KANG, MIDLOTHIAN, VA (US); DARIUSZ WLODZIMIERZ KAWKA, MIDLOTHIAN, VA (US); CHRIS DEMBROSKY, RICHMOND, VA (US)

(21) Appl. No.: 17/196,261

(22) Filed: Mar. 9, 2021

(51) Int. Cl. D21H 21/34; H01M 50/24; H01M 50/218; D06M 11/77; C09D 5/18; C09D 121/02; D21H 13/26; D21H 19/40; D21H 19/58; D21H 17/68

(52) U.S. Cl. CPC D21H 21/34; H01M 50/24; H01M 50/218; D06M 11/77; C09D 5/18; C09D 121/02; D21H 13/26; D21H 19/40; D21H 19/58; D21H 17/68; D06M 2200/30; D06M 2101/36

(57) ABSTRACT

A sheet comprises a nonwoven filamentary substrate and an inorganic refractory layer in contact with at least one surface of the substrate wherein (i) the substrate comprises from 40 to 80 weight percent of uniformly distributed mica and from 20 to 60 weight percent aramid material, the aramid material being in the form of aramid floc or pulp, a combination thereof and polymeric binder and (ii) the refractory layer comprises from 85 to 99 weight percent of platelets and from 1 to 15 weight percent of an adhesion promoter. The sheet is an electrically insulating flame and thermal barrier.

### FIELD OF INVENTION

This invention pertains to a multilayered fire-resistant sheet comprising a substrate layer and an inorganic refractory layer and a method of making the multilayered sheet. Preferably, the substrate layer is a paper.

### BACKGROUND OF THE INVENTION

U.S. Pat. No. 6,322,022 to Fay et al. discloses burn-through resistant systems for transportation especially aircraft.

U.S. Pat. No. 6,670,291 to Tomkins and Vogel-Martin describes a laminate sheet material for flame barrier applications.

U.S. Pat. No. 5,667,886 to Gough et al. describes a composite sheet having a substrate layer, a coating layer and a flexible adhesive layer. The substrate layer is preferably a polyester film. The coating layer contains a mineral, preferably vermiculite.

U.S. Pat. No. 9,441,326 to Kawka pertains to a layered sheet comprising a flame resistant wet-laid nonwoven paper having a first and second surface and an inorganic refractory layer adjacent to at least one surface of the paper wherein the refractory layer has a dry areal weight of from 15 to 50 gsm and the bond strength between the refractory layer and the surface of the paper is from 0.25 lb./in to 0.8 lb./in, wherein the substrate comprises from 40 to 70 weight percent of aramid fibers and from 30 to 60 weight percent of polymeric binder, is hydrophilic, has a smoothness on at least one surface of no greater than 150 Sheffield units, a thickness of from 0.025 to 0.175 mm and a density of from 0.60 to 1.1 g/cc.

United States Patent Publication 2020/0259144 A1 to Kang teaches a laminate useful as cell-to-cell battery insulation, the laminate having an insulating area and a periphery seal area, the insulating area comprising, in order: a first outer layer of paper comprising aramid material and mica, an inner layer comprising a felt or paper of inorganic short fibers and a second outer layer of paper comprising aramid material and mica, the periphery seal area being void of the inner layer and being formed by adhering the first and second outer layers of paper to one another; wherein the periphery seal area extends around the periphery of the insulating area.

There remains an ongoing need for products and methods to provide a thin inorganic refractory layer in a form that may be safely handled and subsequently processed into a multi-layer sheet for uses such as an electrically insulating flame and thermal barrier.

### SUMMARY OF INVENTION

A sheet, comprises a nonwoven filamentary substrate and an inorganic refractory layer in contact with at least one surface of the substrate wherein
the substrate comprises from 40 to 80 weight percent of uniformly distributed mica and from 20 to 60 weight percent aramid material, the aramid material being in the form of aramid floc or pulp, a combination thereof and polymeric binder,
the substrate has a wet tensile strength of at least 3 lb./in in a first direction and at least 2 lb./in in a second direction, the second direction being transverse to the first direction, a dry tensile strength of at least 7 lb./in in a first direction and at least 3 lb./in in a second direction, the second direction being transverse to the first direction, a surface release value from at least one surface of at least 0.25 lb./in, a thickness of from 0.025 to 0.25 mm, a density of from 0.60 to 1.3 g/cc, and an dry areal weight of from 15 to 350 gsm,
the refractory layer comprises from 85 to 99 weight percent of platelets and from 1 to 15 weight percent of an adhesion promoter, and
the sheet is an electrically insulating flame and thermal barrier.

### BRIEF DESCRIPTION OF DRAWINGS

FIG. 1 is a schematic cross section through a multilayered sheet of this invention.

### DETAILED DESCRIPTION OF THE INVENTION

The terms “sheet” and “laminate” may be used interchangeably.

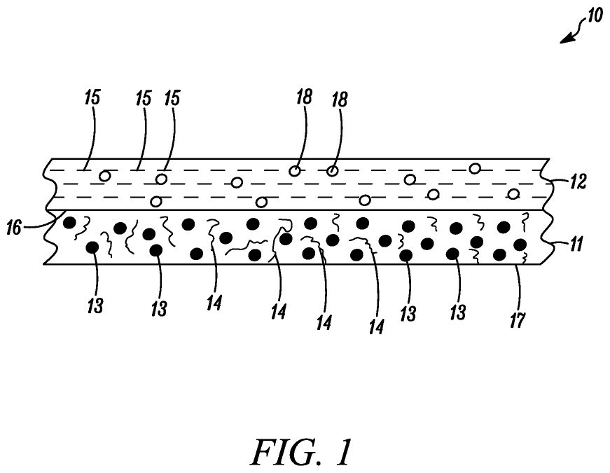

FIG. 1 shows a section through a multilayered sheet 10 comprising a substrate layer 11 and an inorganic refractory layer 12 deposited onto the substrate layer. A preferred substrate material is a high strength fiber wet-laid nonwoven such as a paper.

### Substrate

A flame-resistant high strength substrate has a first and a second surface shown respectively at 16 and 17 in FIG. 1.

In one embodiment, the substrate is a paper that comprises from 40 to 80 weight percent of uniformly distributed mica and from 20 to 60 weight percent aramid material, the aramid material being in the form of aramid floc or pulp, a combination thereof and polymeric binder. The mica and aramid materials are shown respectively at 13 and 14 in FIG. 1.

In some embodiments, the aramid material component of the paper substrate comprises from 40 to 70 weight percent of aramid fibers and from 30 to 60 weight percent of binder. In another embodiment, the aramid component of the substrate comprises from 40 to 55 weight percent of aramid fibers and from 45 to 60 weight percent of binder. A preferred binder is meta-aramid.

It is believed that at least about 40 weight percent mica is needed in the substrate for the substrate to provide the necessary dimensional stability under flame conditions, as evidenced by minimal crack formation, shrinkage, and swelling of the substrate under flame. Also, while amounts of mica greater than 70 weight percent are useful from a fire-blocking and dimensional stability standpoint, it is believed that as the amount of mica in the substrate increases above 70 weight percent the substrate has more propensity to shed the mica therefore, in some applications, amounts of mica greater than 70 weight percent would result in a strength drop to an undesirable level.

By uniformly distributed mica, it is meant the mica can be homogenously distributed throughout the thickness of the substrate layer or the mica can be uniformly arealy distributed throughout a concentrated planar zone in the substrate that is closer to one of the faces of the layer. Implicit in this definition is that the mica is sufficiently distributed to provide the desired performance of the final laminate structure.

The mica can include muscovite or phlogopite mica or blends thereof and may be calcined or uncalcined mica. “Calcined mica” as used herein means mica that is obtained by heating natural mica to a high temperature usually greater than 800 degrees C. and sometimes more than 950 degrees C. This treatment removes water and impurities and improves the temperature resistance of the mica. Calcined mica is normally used in the form of a flake particle and mica of the muscovite type is preferred. “Uncalcined mica” as used herein means mica that is essentially in pure natural form that has preferably been homogenized and purified to remove imperfections and impurities. Uncalcined mica can form a very porous mica layer due to the larger size of the natural mica flakes. A preferred mica for the substrate is calcined mica due to its improved dielectric properties and corona resistance over uncalcined mica.

An exemplary paper substrate is Nomex® T818 or Nomex® T819 both available from DuPont de Nemours Inc., Wilmington, DE hereinafter DuPont.

The thickness of the substrate used in this invention is dependent upon the end use or desired properties of the fire-resistant sheet but, to provide an overall high flexibility and the lowest possible weight, is typically from 1 to 10 mil (0.025 to 0.250 mm) or from 3 to 8 mil (0.075 to 0.203 mm) or even from 3 to 6 mil (0.075 to 0.127 mm) thick. A substrate thickness below 1 mil would result in undesirable features such as a weaker and less dimensionally stable substrate especially when saturated with water. A substrate having a thickness greater than 10 mil would add undesirable weight and stiffness.

In some embodiments, the substrate has a density of from 0.60 to 1.3 g/cc, more preferably from 0.60 to 1.1 g/cc or from 0.65 to 0.95 g/cc or even from 0.70 to 0.85 g/cc. A substrate density of below 0.60 g/cc, coupled with other substrate characteristics, would result in undesirable features such as a weaker and excessively open structure. A substrate density of greater than 0.60 g/cc requires additional densification with suitable densification processes including, but not limited to, calendaring or pressing in a suitable press. In some embodiments the substrate is exposed to a temperature of at least 280 degrees C. during the densification process or even to temperature of 330 to 360 degrees C. The denser substrate allows for a thinner and mechanically stronger substrate especially when substrate densification is carried out at temperature of at least 280 degrees C.

Increased surface smoothness of the densified substrate results in a lower release value from its surface however, when such substrates are required, the incorporation of adhesion promoter in the refractory layer brings the release value up to an acceptable level.

In some embodiments, the basis weight (areal weight) of the substrate is from 15 to 350 gsm or from 60 to 240 gsm, from 100 to 200 gsm or even from 20 to 70 gsm

The bond strength (surface release value) between the surface of the substrate and the refractory layer is at least 0.25 lb./in, more preferably at least 0.80 lb./in or even at least 1.00 lb./in.

The substrate has a wet tensile strength of at least 3 lb./in in a first direction and at least 2 lb./in in a second direction, the second direction being transverse to the first direction. In another embodiment, the substrate has a wet tensile strength of at least 15 lb./in in a first direction and at least 5 lb./in in a second direction, the second direction being transverse to the first direction. In a preferred embodiment the first direction is the long direction within the plane of the substrate, that is, the direction in which the roll of substrate has been made. This is also known as the machine direction. The second direction is sometimes known as the cross direction. By wet tensile strength we mean the tensile strength of the substrate after saturation with water. If the wet tensile strength is less than 3 lb./in in a first direction, there is a high risk of frequent substrate breaks during the refractory layer coating process due to the weight being deposited on the substrate and the tension applied to the substrate.

The substrate has a dry tensile strength of at least 7 lb./in in a first direction and at least 3 lb./in in a second direction, the second direction being transverse to the first direction. By dry tensile strength we mean the tensile strength of a paper that has been conditioned at ambient temperature and humidity, typically 48 to 52 percent Relative Humidity and 22 to 24 degrees C. TAPPI T-402 sp-08 is an exemplary specification defining ambient conditions for paper, board and pulp products.

A dry tensile strength of at least 7 lb./in in a first direction is required to ensure proper handling of the coated substrate through the subsequent process steps, in particular, to ensure tight roll formation during winding to prevent roll sagging and telescoping.

In some embodiments, the substrate has a dry tensile strength of at least 20 lb./in in the first direction and at least 10 lb./in in the second direction.

In other embodiments, the substrate has elongation at break greater than 2.5 percent in any direction when tested according to ASTM D-828-16e1.

In yet other embodiments, the substrate has shrinkage of no greater than 1 percent at 300 degrees C. in any direction when tested according to ASTM D-3394-16.

The aramid fibers of the paper substrate may be meta-aramid, para-aramid or a combination of the two.

The dimensional stability of aramid fibers ensures that the substrate maintains an ability to hold flat (i.e. no moisture related wrinkles or creases) for at least 2 minutes when exposed to one-sided wetting.

The high temperature properties of the aramid fibers ensure thermal and mechanical stability of the substrate during processing steps when the substrate can be exposed to a temperature of 150 degrees C. for at least 10 minutes, that is to say, that the substrate will not change dimensions when subjected to a temperature of 150 degrees C. for at least 10 minutes.

The aramid fibers of the paper substrate can be in the form of floc, pulp, or a combination of thereof. As employed herein the term aramid means a polyamide wherein at least 85 percent of the amide (—CONH—) linkages are attached directly to two aromatic rings. Additives can be used with the aramid. In fact, it has been found that up to as much as 10 percent by weight of other polymeric material can be blended with the aramid or that copolymers can be used having as much as 10 percent of other diamine substituted for the diamine of the aramid or as much as 10 percent of other diacid chloride substituted for the diacid chloride of the aramid.

Floc is generally made by cutting continuous spun filaments into specific-length pieces. If the floc length is less than 2 millimeters it is generally too short to provide a substrate with adequate strength; if the floc length is more than 25 millimeters it is very difficult to form uniform wet-laid substrate webs. Floc having a diameter of less than 5 micrometers and especially less than 3 micrometers is difficult to produce with adequate cross-sectional uniformity and reproducibility. If the floc diameter is more than 20 micrometers it is very difficult to form uniform substrates of light to medium basis weights.

The term “pulp”, as used herein, means particles of fibrous material having a stalk and fibrils extending generally therefrom wherein the stalk is generally columnar and 10 to 50 micrometers in diameter and the fibrils are fine hair-like members generally attached to the stalk measuring only a fraction of a micrometer or a few micrometers in diameter and 10 to 100 micrometers long. Aramid fiber floc is of a similar length to carbon fiber floc. Both meta and para aramid fibers are suitable and are available from DuPont under the tradenames Kevlar® and Nomex® and from Teijin Twaron, Conyers, GA under the tradename Twaron®.

Different thermoset and thermoplastic resins can be used as a polymeric binder in the substrate of this invention. These resins can be supplied in the form of fibrids, flakes, powder, and floc. The term “fibrids” as used herein, means a very finely-divided polymer product of small, filmy, essentially two-dimensional, particles known having a length and width of 100 to 1000 micrometers and a thickness of 0.1 to 1 micrometer. Preferable types of binder resins are aramids, polyimides, phenolics, and epoxies. However, other types of the resins can also be used.

Fibrids are typically made by streaming a polymer solution into a coagulating bath of liquid that is immiscible with the solvent of the solution. The stream of polymer solution is subjected to strenuous shearing forces and turbulence as the polymer is coagulated. The fibrid material of this invention can be selected from meta or para-aramid or blends thereof. More preferably, the fibrid is a meta-aramid.

In one preferred embodiment, the fiber and the polymer binder in the form of fibrids can be slurried together to form a mix that is converted to paper on a wire screen or belt. For illustrative processes of forming papers from aramid fibers and aramid fibrids, reference is made to U.S. Pat. Nos. 4,698,267 and 4,729,921 to Tokarsky; U.S. Pat. No. 5,026,456 to Hesler et al.; U.S. Pat. Nos. 5,223,094 and 5,314,742 to Kirayoglu et al. .

Once the paper is formed it may be calendered to the desired void content and/or apparent density.

### Inorganic Refractory Layer

The inorganic refractory layer 12 is adjacent to at least one surface 16 or 17 of the substrate. The refractory layer has a dry areal weight of from 15 to 50 gsm and a residual moisture content of no greater than 10 percent by weight. In some embodiments, the refractory layer has a dry areal weight of from 20 to 35 gsm and a residual moisture content of no greater than 5 or even 3 percent by weight. The residual moisture is measured after stabilizing the layer at 25 degrees C. and 50 percent Relative Humidity.

The refractory layer comprises inorganic platelets shown as 15 in FIG. 1 that are present in an amount of from 85 to 99 weight percent and an adhesion promoter, shown as 18 in the Figure, present in an amount of from 1 to 15 weight percent. In some embodiments the adhesion promoter is present in an amount of from 1 up to 10 or from 1 to 7 weight percent. In other embodiments the adhesion promoter is present in a range of from 2.5 to 5 weight percent. The refractory layer may also comprise some residual dispersant arising from incomplete drying of the platelet dispersion during manufacture.

The refractory layer has a thickness of from 7.0 to 76 micrometers and more preferably from 7.0 to 50 micrometers. Preferably, the layer has a UL 94 flame classification of V-0. The function of the refractory layer, in which adjacent platelets overlap, is to provide a flame and hot gas impermeable barrier. The inorganic platelets may be clay, such as montmorillonite, vermiculite, mica, talc and combinations thereof. Preferably, the inorganic platelets are stable (i.e., do not burn, melt or decompose) at about 600 degrees C., more preferably at about 800 degrees C. and most preferably at about 1000 degrees C. Vermiculite is a preferred platelet material. Vermiculite is a hydrated magnesium aluminosilicate micaceous mineral found in nature as a multilayer crystal. Vermiculite typically comprises by (dry) weight, on a theoretical oxide basis, about 38 to 46 percent SiO₂, about 16 to 24 percent MgO, about 11 to 16 percent Al₂O₃, about 8 to 13 percent Fe₂O₃ and the remainder generally oxides of K, Ca, Ti, Mn, Cr, Na, and Ba. “Exfoliated” vermiculite refers to vermiculite that has been treated, chemically or with heat, to expand and separate the layers of the crystal yielding high aspect ratio vermiculite platelets. Suitable vermiculite materials are available from Specialty Vermiculite Corp. (SPV), Enoree, S.C. under the trade designations MicroLite and MicroLite HTS-XE. An alternative source is a Micashield® dispersion from Dupre Minerals, Newcastle-under-Lyme, UK.

The thickness of an individual platelet typically ranges from about 5 Angstroms to about 5,000 Angstroms more preferably from about 10 Angstroms to about 4,200 Angstroms. The mean value of the maximum width of a platelet typically ranges from about 10,000 Angstroms to about 30,000 Angstroms. The aspect ratio of an individual platelet typically ranges from 100 to 20,000.

Preferably, the platelets have an average diameter of from 15 to 25 micrometers. In some other embodiments, the platelets have an average diameter of from 18 to 23 micrometers.

In a preferred embodiment, the refractory layer further comprises cations arising from contact, at a temperature of from 10 to 50 degrees C., with an aqueous cationic rich solution at a cation concentration of from 0.25 to 2N. The contact with the cationic solution occurs prior to assembling the refractory layer with the substrate to make a fire-resistant sheet. This cationic treatment provides enhanced stability to the refractory layer on exposure to fluids.

In some embodiments of this invention, the refractory layer may be reinforced by a lightweight open weave fabric scrim so as to provide additional mechanical strength to the layer. The scrim may either be laid into the refractory layer or placed between the refractory layer and the substrate layer. The scrim can be made from natural, organic or inorganic fibers with glass, cotton, nylon or polyester being typical examples. A glass fiber scrim is particularly preferred. The scrim may be a woven or knit structure and has a typical areal weight not exceeding 40 grams per square meter.

In some embodiments, the refractory layer is perforated to enhance bonding to an adhesive layer during subsequent processing. The extent of perforation is determined by experimentation. Preferably, in order to prevent compromising flame barrier properties, an individual perforation should not exceed 2 millimeters in maximum dimension. In a preferable embodiment, individual perforations should be spaced at least 10 millimeters apart. The shape of the perforations is not critical, Suitable perforations include circles, squares, rectangles, ovals and chevrons.

In the context of this invention, an adhesion promoter is a material that increases the bond strength (adhesive strength) between the refractory layer and the substrate. The adhesion promoter also enhances the cohesive strength within the inorganic refractory layer itself i.e. it provides enhanced adhesion between the platelets of the refractory layer. Any suitable adhesion promoter may be used. Exemplary materials include silanes such as oligomeric silanes, acrylics, siloxanes, chlorinated and non-chlorinated polyolefins, phosphate esters and latexes. A charged latex is particularly suitable. If the amount of adhesion promoter exceeds about 15 weight percent of the refractory layer, there is a risk of reduction in the efficacy of the refractory layer as a flame barrier as well as potential adverse effects on toxicity and smoke density when off-gassing in response to the exposure to flame.

### Method of Forming the Multilayered Sheet

A method of forming a layered sheet followed by subsequent treatment comprises the steps of
(i) forming a uniformly mixed aqueous slurry comprising from 7 to 25 weight percent of a non-aqueous component, the non-aqueous component further comprising inorganic refractory platelets and adhesion promoter wherein the platelets are present in an amount of from 85 to 99 weight percent and the adhesion promoter is present in an amount of from 1 to 15 weight percent,
(ii) depositing the slurry onto one surface of a substrate to form a layered sheet, and
(iii) drying the layered sheet at a temperature of from 80 to 110 degrees C. until the residual moisture content in the refractory layer is no greater than 10 percent by weight.

When the non-aqueous component comprises more than 11.5 percent weight percent of the slurry, it is preferable that the slurry is de-aerated (de-gassed) prior to deposition onto the paper. This will reduce defects due to trapped air.

Preferably, when the non-aqueous component content of the slurry is from 7.0 to 8.5 percent and the desired coat weight is 27 gsm or higher, then the coating is applied in multiple steps. For example, a 30 gsm total coat weight could be achieved by two applications of slurry each providing 15 gsm of refractory material or by three applications at 10 gsm.

In some embodiments, the layered sheet is dried at a temperature of from 80 to 110 degrees C. until the residual moisture content in the refractory layer is no greater than 3 percent by weight. In some other embodiments, the method comprises an optional step of increasing the drying temperature in step (iii) to from 150 to 180 degrees C. after the residual moisture content in the refractory layer is less than 10 percent.

Preferably the non-aqueous component comprises from 10 to 20 weight percent of the slurry. In some embodiments, especially when a slot die is being used, the non-aqueous component comprises from 10 to 13 weight percent of the slurry. In other embodiments, when knife-over-roll coating is employed, the non-aqueous component comprises from 15 to 20 weight percent of the slurry.

Preferably the layered sheet, when wet, has a shrinkage no greater than 2 percent.

Prior to coating the substrate with non-aqueous component material the substrate may optionally be treated to promote better wetting. An example of such a treatment is plasma or corona treatment.

Preferably, the refractory platelets have a particle thickness of from 5 A to 5000 A and an average diameter of from 15 to 25 micrometers.

In some embodiments, the sheet has a minimum dielectric breakdown strength of 20 kV/mm when tested according to ASTM D-149-20.

### Use of the Multilayered Sheet

One use of the multilayered fire-resistant sheet is as a flame-barrier layer for thermal management applications for an aircraft. An example of such an application is a thermal acoustic blanket as described in U.S. Pat. No. 8,292,027.

Another use is as a battery protection system providing thermal and electrical insulation management as well as flame barrier protection. An example of this use is described in United States patent application publication number 2020/0259144 A1.

Further uses may also be envisaged.

### TEST METHODS

The wet tensile strength of the substrate was measured according to TAPPI T456 om-10 Tensile Breaking Strength of Water-saturated Paper and Paperboard (“Wet Tensile Strength”).

The dry tensile strength of the substrate was measured according to TAPPI T494 om-06 Tensile Properties of Paper and Paperboard (Using Constant Rate of Elongation Apparatus).

The surface smoothness of the substrate was measured according to TAPPI T538 om-08 Roughness of Paper and Paperboard (Sheffield Method).

The thickness of the sheet and component layers of the sheet was measured as per ASTM D-374-16.

The dimensional stability of the sheet was rated based on its ability to hold flat i.e. no related wrinkles or creases for at least 2 minutes when exposed to one-sided wetting and when exposed to the flame temperatures encountered in the FAA and TPP tests. Ratings were “Low”, “Medium” or “High”.

The dry areal weight (basis weight) of the refractory layer was obtained by measuring the weight of substrate prior to coating with refractory layer, measuring the weight of the sheet and subtracting the substrate weight from the sheet weight. Standards used were ISO 536 (1995) Determination of Grammage, TAPPI T 410 Gram mage of Paper and Paperboard (Weight per Unit Area) or ASTM D-3776-96.

The density of the substrate is a calculated value based on the measured values of substrate thickness and basis weight.

The moisture content of the refractory layer was measured according to ISO 287 (1985) Determination of Moisture Content—Oven Drying Method.

Flame resistance of the sheets were assessed by two methods:
(i) Title 14 CFR, Part 25-Subpart D, §25.855 Cargo or Baggage Compartments, Appendix F, Part III, paragraph (a)(3). This is referred to hereafter as the FAA Test.
(ii) ASTM D1408 — 1987 Standard Test Method for Thermal Protective Performance of Materials for Clothing by Open-Flame Method (TPP). The key features of this test are a 950 degree C. Flame at 2 cal/sec heat flux (50 percent flame/50 percent radiant) with samples being exposed to the direct flame for 5 minutes to replicate a required thermo-mechanical stress level to be exerted on the flame barrier composite sheet during the FAA test. Samples have been assigned Pass/Fail score based on their ability to withstand exposure to a direct flame impinging on the bottom surface of the sample without the flame being able to penetration the plane of the sample.

Dielectric breakdown strength was tested according to ASTM D-149-20.

The bond strength between the refractory layer and the substrate was assessed by the ease of separation of the two layers and was categorized as “Good”, “Better”, “Best” or “Poor”. A result was considered to be in the good, better or best categories if there were no practical ways to remove any substantial sections of the refractory layer from the substrate without the aid of a reinforcing substrate bonded to the exposed side of the refractory film layer. A further positive factor in the assessment was if the inorganic refractory material remained attached to the surface of the substrate even after substantial flexing.

### EXAMPLES

In the following examples, all parts and percentages are by weight and all degrees in centigrade unless otherwise indicated. Examples prepared according to the current invention are indicated by numerical values. Control or Comparative Examples are indicated by letter.

### Example 1

Vermiculite dispersion concentrated to a solids content of 15 percent and containing 5 percent by weight of solids of a charged latex adhesion promoter was coated on a 5 mil thick meta-aramid paper, using a fixed gap coating system to form a refractory layer on the paper. The paper was Nomex® T 818 from DuPont, with the vermiculite dispersion being DM217 from Dupre Minerals. The T818 paper comprised mica platelets, meta-aramid fiber floc and polymeric binder in the form of fibrids.

The paper had a basis weight of 148 gsm, a density of 1.13 g/cc, a dry tensile strength of 52 N/cm in the machine direction and 38 N/cm in the cross direction. The coated paper was dried for 15 minutes in an air flotation oven at a temperature not exceeding 160 degrees C. until the vermiculite layer had moisture content below 5 percent. The refractory layer had a dry coat weight of 32 gsm. The sheet had a thickness of 0.15 mm. The bond strength was assessed as “Better”. Dimensional stability was rated as “High”.

The 2-layer sheet was subjected to the FAA Test. When exposed to a flame on the vermiculite layer side, the sample showed a good resistance to flame propagation, with the vermiculite layer acting as an effective flame barrier. When tested as per the TPP flame resistance test, the sheet did not allow flame penetration after 5 minutes. Both tests were recorded as “Passed”.

### Example 2

This example was prepared in a similar way to Example 1 except that the amount of adhesion promoter was 3 percent by weight of solids. The refractory layer had a weight of 30 gsm.

The bond strength was deemed to be “Good” and the TPP test “Passed”. Dimensional stability was rated as “High”.

### Comparative Example A

Comparative Example A was Nomex® XF 20, a product formerly available from DuPont. Nomex® XF 20 is a two layered fire-resistant sheet comprising a substrate and a refractory layer. The sheet had a nominal thickness of 6 mil when measured according to ASTM D-374. The substrate layer was 5 mil Nomex® 413 paper having a nominal basis weight of 42 gsm when measured according to ASTM D-3776-96. This product is further described in U.S. Pat. No. 9,316,342 to Kawka. The refractory layer had a nominal basis weight of 30 gsm when measured according to ASTM D 646-13.

The sheet passed both the FAA and TPP flammability tests. The bond strength was rated as “Poor”. Dimensional stability was rated as “Medium”.

### Comparative Example B

This example was prepared as per Example 1 of US Patent Application Publication number 2020/0259144 to Kang and is briefly described below.

A sheet was made having first and second outer layers of Nomex® T818 paper and an inner layer of Superwool® Plus 332-E paper available from Morgan Advanced Materials, Augusta, Ga. The T818 paper had a thickness of 3 mil (0.076 mm). The Superwool® Plus 332-E paper is made from an alkaline-earth silicate wool and an acrylic binder and had a measured thickness of approximately 40 mil (1.0 mm).

The sheet passed the TPP test but, due to the relatively high thickness of the sheet components, the sheet had poor flexibility, i.e. was too rigid and was not suitable for use in applications where curvature of the sheet is required. Dimensional stability was rated as “High”.

### Comparative Example C

This example consisted solely of 6 mil (0.152 mm) T818 paper having a basis weight of 180 gsm. The sample failed the FAA flame test. Dimensional stability was rated as “High”.

### Comparative Example D

This example consisted solely of T818 paper having a nominal thickness of 8 mil (0.20 mm) and a nominal basis weight of 240 gsm.

The sample failed the FAA flame test. Dimensional stability was rated as “High”.

### Comparative Example E

This example consisted solely of 10 mil (0.25 mm) T818 paper having a nominal basis weight of 298 gsm. The sample failed the FAA flame test. Dimensional stability was rated as “High”.

### Comparative Example F

The vermiculite layer was formed by depositing vermiculite dispersion with a solids content of 10.8 weight percent, available from SPV as grade ML963HS, on 10.8 mil thick hydrophilic RagKraft paper using a slot die coating system. The paper, which later functioned as a release paper, was obtained from Cottrell Paper Company, Rock City Falls, N.Y. as brand DPT3OR. The coated paper was dried for 15 minutes in an air flotation oven at a temperature not exceeding 110 degrees C. until the inorganic refractory layer had a moisture content below 5 percent. Differential drying temperatures were applied to the top (vermiculite side) and the bottom (release paper side). The drying profile on the top side was 5 minutes at 49 degrees, 5 minutes at 60 degrees and 5 minutes at 71 degrees. The drying on the bottom side was maintained for 15 minutes at 99 degrees. The refractory layer had a nominal dry coat weight of 30 gsm.

The final sheet laminate was made by adhesively bonding 5 mil T818 Nomex® paper to the vermiculite side of the RagKraft release paper—inorganic refractory layer formed above. The adhesive was a fire-retardant solvent-based thermoplastic adhesive type RK35502K having a nominal dry areal weight of 22 gsm and was obtained from Dunmore Corporation, Bristol, PA. The adhesive was applied via a gravure laminator. The bonded structure was allowed to cure for 72 hours at ambient temperature and under pressure. Once cured, the RagKraft release paper was removed. The sheet had a thickness of 0.17 mm and an areal weight of 210 gsm.

The sheet passed both the FAA and TPP flammability tests. The bond strength was rated as “Best”. Dimensional stability was rated as “High”. Although this example gave acceptable results, other features made it a less desirable option than Examples 1 or 2. Such features are a higher sheet weight, more material to burn in the event of a fire incident, additional fire, smoke and toxicity (FST) issues from using an adhesive, flame-over risk from retained solvent in the adhesive and an additional processing step to incorporate the adhesive.

### Comparative Example G

This example was prepared as per Comparative Example F except that the T818 paper was replaced with mica free 5 mil Nomex® Type 411 paper, which was also from DuPont. The sample passed both the TPP and FAA tests but the test sample from the FAA protocol was found to be cracked after exposure and deemed to be sub-optimal. The bond strength was evaluated as being in the “Best” category. The dimensional stability when exposed to flame was only “Medium”.

### Comparative Example H

This example was prepared as per Comparative Example G with the exception that 23 mil Nomex® 411 paper having a basis weight of 205 gsm was used instead of the 5 mil Nomex® 411 substrate. Dimensional stability was rated as “Low”. This sample failed the FAA test.

The test results are summarized in the Table 1 below.

An * indicates a projected result.

TABLE 1

| | | | | | Dielectric |
|---|---|---|---|---|---|
| | | | | | Breakdown |
| | Flammability | Flammability | Bond | Dimensional | Strength |
| Examples | per FAA Test | per TPP Test | Strength | Stability | (kV/mm) |
| Ex 1 | Passed | Passed | Better | High | 25.6 |
| Ex 2 | Pass* | Passed | Good | High | Not Tested |
| Comp A | Passed | Passed | Poor | Medium | Not Tested |
| Comp B | Not Tested | Passed | Not | High | Not Tested |
| | | | Applicable | | |
| Comp C | Failed | Passed | Not | High | 39 |
| | | | Applicable | | |
| Comp D | Failed | Passed | Not | High | 39.3 |
| | | | Applicable | | |
| Comp E | Failed | Passed | Not | High | 39 |
| | | | Applicable | | |
| Comp F | Passed | Passed | Best | High | 41.9 |
| Comp G | Passed | Passed | Best | Medium | Not Tested |
| Comp H | Failed | Pass* | Best | Low | Not Tested |

What is claimed is:

1. A sheet, comprising a nonwoven filamentary substrate and an inorganic refractory layer in contact with at least one surface of the substrate wherein
the substrate comprises from 40 to 80 weight percent of uniformly distributed mica and from 20 to 60 weight percent aramid material, the aramid material being in the form of aramid floc or pulp, a combination thereof and polymeric binder,
the substrate has a wet tensile strength of at least 3 lb./in in a first direction and at least 2 lb./in in a second direction, the second direction being transverse to the first direction, a dry tensile strength of at least 7 lb./in in a first direction and at least 3 lb./in in a second direction, the second direction being transverse to the first direction, a surface release value from at least one surface of at least 0.25 lb./in, a thickness of from 0.025 to 0.25 mm, a density of from 0.60 to 1.3 g/cc, and an dry areal weight of from 15 to 350 gsm,
the refractory layer comprises from 85 to 99 weight percent of platelets and from 1 to 15 weight percent of an adhesion promoter, and
the sheet is an electrically insulating flame and thermal barrier.

2. The sheet of claim 1 wherein the substrate is a paper.

3. The sheet of claim 1 wherein the polymeric binder of the aramid material of the substrate comprises aramid fibrids.

4. The sheet of claim 1 wherein the inorganic platelets are of vermiculite, clay, montmorillonite, mica, talc or combinations thereof.

5. The sheet of claim 1 wherein the refractory layer has a dry areal weight of from 15 to 50 gsm.

6. The sheet of claim 1 wherein the refractory layer has a residual moisture content of no greater than 10 percent by weight.

7. The sheet of claim 1 wherein the adhesion promoter of the refractory layer is a silane, an acrylic, a siloxane, a chlorinated or non-chlorinated polyolefin, a phosphate ester or a latex.

8. The sheet of claim 1 wherein the aramid material of the substrate comprises from 40 to 70 weight percent of aramid fiber and from 30 to 60 weight percent of polymeric binder.

9. The sheet of claim 1 having a minimum dielectric breakdown strength of 20 kV/mm when tested according to ASTM D-149-20.

10. The sheet of claim 1 wherein the substrate has elongation at break greater than 2.5 percent in any direction when tested according to ASTM D-828-16e1.

11. The sheet of claim 1 wherein the substrate has shrinkage of no greater than 1 percent at 300 deg C in any direction when tested according to ASTM D-3394-16.

12. A thermal and acoustic blanket for an aircraft comprising the sheet of claim 1.

13. A battery protection system comprising the sheet of claim 1.
